(19) United States
(12) Patent Application Publication
(10) Pub. No.: US 2023/0249908 A1
(43) Pub. Date: Aug. 10, 2023

(54) STORAGE RACK WITH A VERTICALLY MOVABLE COMPARTMENT SYSTEM

(71) Applicant: conTeyor International nv, Merelbeke (BE)

(72) Inventor: Dick STEINBERG, Merelbeke (BE)

(21) Appl. No.: 18/004,500

(22) PCT Filed: Jul. 9, 2021
(86) PCT No.: PCT/IB2021/056181

§ 371 Date: Jan. 6, 2023

(30) Foreign Application Priority Data
Jul. 9, 2020 (BE) 2020/5513

(51) Int. Cl. B65G 1/02; A47B 51/00

(52) U.S. Cl. CPC B65G 1/026; A47B 51/00

(57) ABSTRACT

In a first aspect, the invention relates to a storage device comprising a frame and a compartment system suspended within the frame, the compartment system providing at least two n levels of storage compartments, accessible from a front side of the device, and suitable for storing general cargo, the device further being adapted for vertical movability of the compartment system. In particular, the compartment system is rectangularly suspended from four lifting belts extending vertically upwards. In a further aspect, the invention provides the use of the storage device.

### TECHNICAL FIELD

The invention is related to storage devices for storage and/or transport of goods. In particular, the invention focuses on storage racks with a vertically movable compartment system.

### PRIOR ART

Storage racks with flexible and movable compartments are known as such in the prior art.

For example, FR 2 845 354 (Européenne de Conception de Conteneurs pour I′Automobile) describes a mobile storage rack with a support structure and with a flexible compartment structure. The compartment structure provides compartments accessible from a front of the storage rack. Furthermore, the compartment structure is centrally suspended within the support structure, under a central belt. Further belts extend obliquely upwards, from the four upper corners of the compartment structure, down to the central belt. The compartment structure can therefore be raised and lowered centrally. It is true that such a suspension requires a rectangular suspension frame which reinforces the upper side of the flexible compartment structure, which has the disadvantage of making the movement heavier. Another disadvantage of the central suspension is that the compartment structure may tilt (e.g. in the case of a non-symmetrical load) within the support structure. This inclination can further complicate or even completely block the vertical movement of the compartment structure.

Furthermore, masses are provided along the belt. They compensate for the empty weight of the compartment structure. The masses and the belt are movable in a vertical slot profile of the support structure, which extends along the front side. A disadvantage here is that the support profile makes access to some storage compartments more difficult. Also, the support profile (and therefore also the masses contained in it) is quite limited in size. This limits the weight that can be compensated.

Furthermore, operating means are provided on the belt, also accessible from the front. In addition, they can be secured over the support profile, behind corresponding stops. This allows to lock the compartments in defined vertical positions. An obvious disadvantage is that the stops only provide locking in one direction.

Furthermore, US 10 081 490 (Diverse Global) describes a telescopic storage rack with a base frame and an extension frame. A flexible compartment system is suspended directly from the extension frame, within the base frame. The extension frame is movable upward and downward relative to the base frame. This is accompanied by a corresponding upward and downward movement of the compartment system. A disadvantage is that the extension frame makes the movement considerably more difficult/heavier.

Finally, CZ 29 088 and SK 7781 (Keypack) describe another frame within which a flexible compartment system is suspended. The compartment system is suspended from belts. Said belts are wound around a central shaft at the top. The rotation of the central axis determines the upward and downward movement of the compartments. This rotation can be controlled from a laterally placed crank at the bottom. As a disadvantage, the central axis limits the usable height of the storage rack. As a further disadvantage, the side crank limits the usable width of the storage rack. Certainly in a logistics context, it is important that the storage rack uses the available space as efficiently as possible. Furthermore, the mechanism of operation via a side crank is quite complex.

A number of important characteristics of storage devices and storage racks are smooth movement, efficient use of space, good handling, easy accessibility, high durability, low weight, and low production cost and material costs.

The present invention contemplates a new and improved storage device. Among other things, an attempt is made to provide a solution for one or more of the above-mentioned problems.

### SUMMARY OF THE INVENTION

To this end, in a first aspect, the invention provides a storage device according to claim 1. The device provides a compartment system that is vertically movable within a frame, with compartments for storing general cargo. In particular, the compartment system is rectangularly suspended from four lifting belts extending vertically upwards.

Different from the suspension in FR 2 845 354, the invention provides a rectangular suspension from four vertical lifting belts, preferably at the level of the four corners. This makes the compartment system less likely to skew or get blocked within the frame. The compartment system preferably moves along rails via wheels or sliders, which further facilitates the movement.

In a further embodiment, the invention provides a countermass that moves reciprocally with the compartment system (claim 2). This can support the manual movement of the compartment system, both in loaded and unloaded conditions. Preferably, the countermass is plate-shaped (claim 4), moving parallel to the plate shape along the device. This compact design allows to maximise the usable dimensions of the storage device. With further preference, said compartments are accessible from the front, and the countermass moves along a side different from the front (claim 3). The countermass therefore does not hinder access to the compartments.

Preferably, the compartment system can be operated from the front, via cross bars (claim 10), as well as position-locked, via a plunger lock or other transverse lock (claim 12). Optionally, the device provides stops to limit the vertical movement of the compartment system between a lower position and an upper position (claim 13). Furthermore, the transverse lock is optionally adapted to lock the position of the compartment system in both limit positions (claim 14).

In a further aspect, the invention provides for the use of the storage device according to the first aspect of the invention (claim 16).

Clearly, the invention provides a good weight distribution via four belts, a smooth movement via guide means along guideways, a compact arrangement of the countermass, and a high-performance position locking via the plunger lock or other locking means.

### DESCRIPTION OF THE DRAWINGS

FIGS. 1A-B are perspective views of a storage rack, according to a possible embodiment of the invention.

FIGS. 2A-C schematically illustrate the raising and lowering of a compartment system, according to a possible embodiment.

FIGS. 3A-C illustrate another transverse lock for locking the movement of the compartment system, according to a possible embodiment.

### DETAILED DESCRIPTION

The invention relates to a storage device suitable for the storage of general cargo, as well as the use of the storage device.

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, ‘a’ and ‘the’ refer to both the singular and the plural, unless the context presupposes otherwise. For example, ‘a segment’ means one or more segments.

When the term ‘around’ or ‘about’ is used in this document with a measurable quantity, a parameter, a duration or moment, and the like, then variations are meant of approx. 20% or less, preferably approx. 10% or less, more preferably approx. 5% or less, even more preferably approx. 1% or less, and even more preferably approx. 0.1% or less than and of the quoted value, insofar as such variations are applicable in the described invention. However, it must be understood that the value of a quantity used where the term ‘about’ or ‘around’ is used, is itself specifically disclosed.

The terms ‘comprise’, ‘comprising’, ‘consist of’, ‘consisting of’, ‘provided with’, ‘have’, ‘having’, ‘include’, ‘including’, ‘contain’, ‘containing’ are synonyms and are inclusive or open terms that indicate the presence of what follows, and which do not exclude or prevent the presence of other components, characteristics, elements, members, steps, as known from or disclosed in the prior art.

The term ‘belt’ and derivative terms, as used herein, are to be broadly understood. In the first instance, these terms may refer to a ‘belt’, a ‘cord’, a ‘band’, a ‘line’, a ‘cable’, a ‘wire’, a ‘rope’ or other linear pulling means that provides transverse flexibility. Preferably, a belt can be guided at least around a guide such as a rolling element or sliding element. It is also preferably possible to roll up belts on bobbins.

Quoting numerical intervals by endpoints comprises all integers, fractions and/or real numbers between the endpoints, these endpoints included.

In a first aspect, the invention relates to a storage device comprising a frame and a compartment system suspended within the frame, the compartment system providing at least a lower level of storage compartments and an overlying level of storage compartments, accessible from a front of the device, and suitable for storing general cargo, the device being further adapted for vertical movability of the compartment system between a lowered position and a raised position, within the frame,
in which lowered position the lower level has collapsed, with the overlying level above it erected and accessible, and
in which raised position the lower level is erected and accessible, with the overlying level above it raised.

In particular, the compartment system is rectangularly suspended from four lifting belts extending vertically upwards. Preferably, the storage device is a storage rack.

It is preferably a fixed, rigid frame (instead of a base frame plus a telescopic extension frame). A fixed and integral frame makes it possible to make a suitable compromise between maximum strength and load-bearing capacity on the one hand, and minimum weight on the other. This is especially important in transport applications. Optionally, the frame is mobile. Optionally, the frame is fitted with one or more wheels at the bottom. In a non-limitative version, the frame provides two wheels and two support feet at the bottom. Alternatively, the frame provides four wheels at the bottom. The frame preferably encloses a substantially beam-shaped volume, within which the compartment system is provided. With further preference, the frame mainly provides support structures along the ribs of the beam shape. This maximises front/back/left and/or right side accessibility. Optionally, the frame includes four corner posts that rectangularly enclose the compartment system.

Preferably, the compartment system provides a plurality of storage compartments. Preferably there are two or more levels of storage compartments. With further preference, there are two levels: a lower and an upper level. Hereinafter, the terms ‘overlying’ and ‘upper’ are interchangeably used, without this limiting the invention to two levels or more than two levels. Both the lower and the overlying level provide at least one storage compartment. Optionally, they each provide a multitude of compartments. Optionally, they each provide a grid of storage compartments that are provided next to and above each other. Each level can provide two or more superimposed series of side-by-side compartments. It is preferably a rectangular grid. Preferably, the compartments are at least accessible from the front, when erected.

The compartment system is vertically movable between a raised position and a lowered position, within the frame. In the lowered position, the lower level of storage compartments is collapsed or folded up. Preferably, it hereby takes on a more compact form. Preferably, the compartment material of at least the lower level of storage compartments is flexible. Preferably, it automatically assumes the compact form. Preferably, at least the lower storage compartments are flexible. With further preference, both the lower and the upper storage compartments are flexible.

‘Vertical movability’ of the compartment system, as referred to herein, indicates that at least a part (e.g., the overlying/upper level of storage compartments) is vertically movable within the frame. The invention now further provides a rectangular suspension of the compartment system from four lifting belts extending vertically upwards. Preferably, the lifting belts extend vertically upwards from four corner parts at the top of the compartment system. An advantage is that the compartment system will skew less quickly as a result. The compartment system per se is three-dimensional, thus preferably the four straps are used to hold the compartment system up rectangularly below its top surface, from the four corners.

It is therefore not necessary to reinforce the top of the compartment system in a rectangular manner. In FR 2 845 354, however, this is necessary so that the top side can withstand inward forces caused by the obliquely upwardly extending lifting belts.

In a further or alternative embodiment, the device further comprises a countermass, adapted to move reciprocally with the compartment system, between a raised position and a lowered position. The countermass makes it possible to at least partially compensate for the weight of the compartment system and/or the general cargo loaded in it. Preferably, the countermass comprises a substantial mass (e.g. at least 10 times the total weight of lifting belts). Preferably, the countermass comprises an inexpensive material of relatively high mass density. Optionally, the countermass comprises steel. Optionally, the countermass comprises sheet steel material. Preferably, the countermass compensates for at least the empty weight of the upper level of storage compartments.

In a further or alternative embodiment, the countermass is adapted to move along a side of the storage device, different from the front. The countermass thus does not hinder access to the storage compartments from the front. Optionally, the countermass is provided along the left side, the right side or the rear of the device.

In a further or alternative embodiment, the countermass is substantially plate-shaped, adapted to move along and parallel to the storage device. With further preference, the countermass moves between two adjacent corner posts of the frame. This compact design allows to use the available space as efficiently as possible. Optionally, the countermass is substantially rectangular and plate-shaped.

In a further or alternative embodiment, the lifting belts bend laterally at the top of the frame and are coupled vertically downwards to the countermass. Optionally, they bend at the height of four upper corners of the frame. Optionally, four belt guides are provided at the top of the frame (e.g. rolling elements or sliding elements), adapted to bend the vertically upward lifting belts laterally and/or downwards. Belt guides make it possible to very compactly bend the tension force in the pulling belts (under the weight of the compartment system) and to direct it vertically downwards towards the reciprocally moving countermass (provided along one side of the storage device). Preferably, the pulling belts provide a direct mechanical connection between the compartment system and the countermass.

In a further or alternative embodiment, the lifting belts are combined in pairs at the top of the frame, each pair of combined lifting belts being coupled downwards to the countermass. Optionally, two first belt guides are positioned at the top, on a side opposite the countermass. These first belt guides provide for the lateral bending (total 90°) of two corresponding, first pulling belts. Two second belt guides, positioned on the side of the countermass, provide for both the sideways and downward bending (total 180°) of two corresponding, second pulling belts, as well as the combination of the first and second pulling belts. This, vertically above the countermass.

In a further or alternative embodiment, the lifting belts are steel cables, and the belt guides are rolling elements on bearings. This embodiment is advantageous for reducing friction when manipulating the compartment system.

The compartment system in itself is three-dimensional. To keep it rectangularly stable under its upper surface, four belts or lines are used at the upper corners. The countermass is two-dimensional. Thus, the four belts or lines are combined into two belts or lines. Each pair engages the countermass combined. Preferably, the countermass comprises an upper edge part, to which upper edge part said pairs of lifting belts are coupled, each near a respective upper corner of the countermass. This is sufficient to keep the (one-dimensional) top edge stable.

In a further or alternative embodiment, the countermass is provided with guide means, adapted to guide the countermass rectangularly between two guideways provided on the frame. The countermass cannot therefore skew or block. It is limited to a vertical upward and downward movement. This is especially advantageous when tension forces in the belts are not evenly distributed. For example, when manually moving the storage compartments from a cross bar at the front (see below). Or, for example, when loading is not symmetrically (forward-backward). The countermass then acts as a part that forces the compartment system into a straight position.

A plate shape of the countermass has the particular advantage that it comprises a certain height. Lateral guiding means (e.g. wheels, sliders, a sliding side edge) can be provided at least at the top and bottom. Preferably, such guide means are coupled to lateral guide means (e.g. a rail, groove, rib). They then provide a rectangular containment and guidance of the countermass, so that it is limited to a vertical upward and downward movement. The countermass cannot skew or block.

In a further embodiment, the countermass comprises at least four wheels, preferably at least six wheels. The countermass comprises at least two wheels on each side which are oriented in transverse directions. A first wheel is oriented parallel to the frame and a second wheel is oriented transversely to the frame. The first wheel is preferably provided at the bottom. The second wheel is preferably provided at the top. Preferably, the countermass comprises a third wheel at the top, which is oriented parallel to the frame. This embodiment is advantageous to reduce friction between the countermass and the frame and/or lateral guide means to which the wheels are coupled. This is also advantageous to avoid blocking of the countermass during vertical movement. The first and optionally third wheels avoid friction and locking in a direction parallel to the frame, for instance through one-sided manipulation of the compartment system, and the second wheels in a direction transverse to the frame, for instance by forces exerted by the lifting belts.

In a further or alternative embodiment, the compartment system provides at the front a lower cross bar and an overlying cross bar, which can be moved vertically in the frame, from which cross bars the lower and the overlying level are suspended, respectively. Preferably, the cross bars are relatively rigid with respect to the frame. They allow easy handling of the compartment system. Preferably, such horizontal cross bars are provided at the front as well as at the rear. Preferably they extend through loops and/or eyes formed by the compartment material of the storage compartments. Preferably, the compartment system comprises compartments arranged side by side with standing wall parts between them. These wall parts extend from the front to the rear. They form eyes at the level of the cross bars, optionally provided with reinforcement rings. Such (flexible) wall parts provide to an important extent the stable suspension of a level of storage compartments, under at least a cross bar at the front and a cross bar at the back.

In a further or alternative embodiment, the left-hand end parts and right-hand end parts of the said cross bars are respectively coupled to a left and a right guide assembly, which guide assemblies are movable vertically along the frame. Optionally, four such guide assemblies are movable along four corner posts of the frame. Optionally, at least one corner post comprises a profiling forming a rail for enclosing corresponding guides (e.g. rolling elements or sliding elements) provided on the compartment structure.

Preferably, the upper level of compartments is suspended from upper cross bars. Preferably the lower level of compartments is suspended from lower cross bars. With further preference, the lower and upper bars are coupled at either end to guide assemblies movable along the corner posts of the frame. Preferably, the four pulling belts are coupled to the four guide assemblies. Thus, the pulling belts are rigidly coupled to both the lower and upper levels, independently of each other. A heavily loaded lower level does not have the effect of bending the compartment material of the upper level.

In a further embodiment, guide assemblies formed on one side by the left end parts of said cross bars are connected to each other by means of two cross beams and guide assemblies formed on one side by the right end parts of said cross bars are connected to each other by means of two cross beams. The two cross beams are preferably crossed cross beams. This embodiment is advantageous because it provides a rigid guide assembly on the side formed by the left-hand end parts of the said cross bars and on the side formed by the right-hand end parts of the said cross bars, so that the compartment system does not or hardly deform during movement.

In a further or alternative embodiment, at least one guide assembly is provided with a transverse lock, for selectively locking the vertical movement of the guide assembly. The guide assembly is preferably already limited to a vertical upward or downward movement. Locking such a rigid guide assembly in a vertical position allows a high-performance locking. Furthermore, at least the counterweight (as described above) will maintain the compartment material in a straight position. A transverse lock, for example a plunger lock based on a transversely movable pin in a locking hole, allows locking in two directions. Preferably, at least one of the two guide assemblies at the front is equipped with such a lock. This allows blocking of the compartment system from the front.

In a further embodiment the transverse lock is a lever, wherein the lever is movable between a first position and a second position. The lever is at rest in both the first and second positions. This means that the lever remains in the first position or second position without manipulation. In the first position, the movable pin is received in the locking hole. In the second position, the movable pin is removed from the locking hole. In the second position, the movable pin of the frame or a rail included in a corner post of the frame, along which the guide assembly is vertically movable, is removed. This embodiment is advantageous because the movable pin cannot rub against the frame or the rail during the vertical movement of the guide assembly, so that manipulation of the compartment system is simple.

In a further or alternative embodiment, the frame provides a lower stop and an upper stop that limit the movement of at least one guide assembly, between a lower and an upper position. Preferably, the lower position corresponds to the lowered position of the compartment system, and the upper position to the raised position of the compartment system, by lying directly against the stop. Optionally, the lock is adapted to selectively lock the guide assembly in both the lower and upper positions.

In a further aspect, the invention relates to the use of the above-described storage device, comprising loading general cargo into and/or unloading general cargo from one or more of the storage compartments. The same features and advantages can therefore be reiterated in this regard.

In what follows, the invention is described by way of non-limiting examples and figures illustrating the invention, and which are not intended to and should not be interpreted as limiting the scope of the invention.

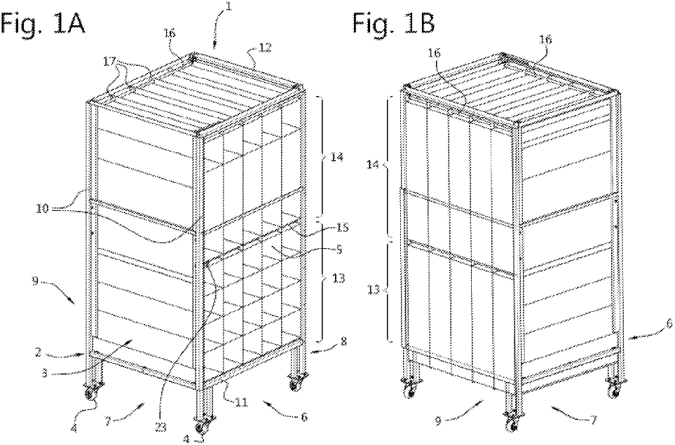

FIGS. 1A-B are perspective drawings of a storage rack 1, according to a possible embodiment. The storage rack 1 comprises a frame 2 and a compartment system 3 which is suspended within the frame 2. The frame 2 comprises four upright corner posts 10, between a rectangular lower frame 11 at the bottom and a rectangular upper frame 12 at the top. At the bottom, the lower frame 11 is further provided with wheels 4 for movability. The compartment system 3 itself forms a plurality of compartments 5, suitable for storing general cargo (not shown). The compartments 5 are only accessible from the front 6. See FIG. 1A. The compartments 5 are closed, or in any case inaccessible, along the left side 7, the right side 8 and the rear side 9. Optionally, they are closed dust-tight along those sides 7, 8, 9.

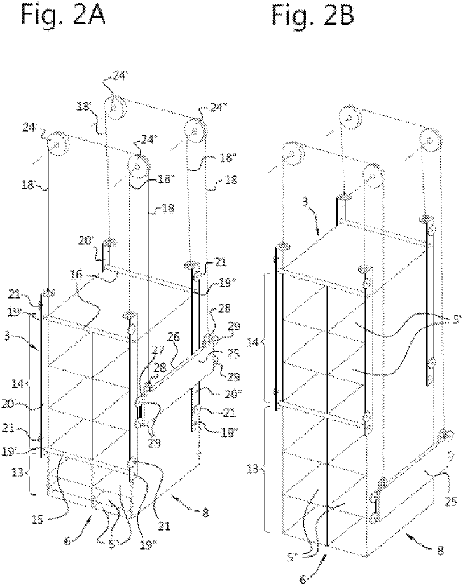

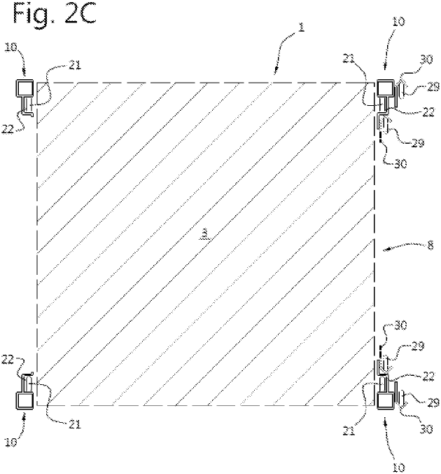

The compartment system 3 comprises at least a lower level 13 and an overlying level 14 of storage compartments 5. Preferably, the storage compartments 5 of both the lower level 13 and the overlying level 14 are flexible. The lower level 13 is suspended from lower cross bars 15; the upper level 14 is suspended from upper cross bars 16. There are two lower and two upper cross bars 15, 16: always one at the front 6 and one at the rear 9 of the storage rack 1. The cross bars 15, 16 extend horizontally between the left and right sides 7, 8 of the storage rack 1. They extend through eyes 17 formed by the compartment material of the storage compartments 5. These eyes are optionally equipped with reinforcement rings. The compartment system 3 is vertically movable in the frame 2, between a lowered position and a raised position. FIGS. 1A-B only show the raised position of the compartment system 3. The cross bars 15, 16 at the front 6 have the advantage that they can be easily gripped by the user for manual movement of the compartment system 3. The vertical movement of the compartment system 3 is further illustrated with reference to FIGS. 2A-C.

FIGS. 2A-C schematically illustrate the raising and lowering of a compartment system 3, according to a possible embodiment. The lower level 13 of storage compartments 5′ is suspended under lower cross bars 15 at the front and rear. The upper level 14 of storage compartments 5″ is suspended under upper cross bars 16 at the front and rear. The cross bars 15, 16 each form left and right end parts 19′, 19″ coupled together with corresponding left and right guide assemblies 20′, 20″. The upper and lower cross bars 15, 16 are thus coupled to the same guide assemblies 20′, 20″, respectively at the front and rear; optionally, the upper level 14 of storage compartments 5″ is held taut between them, between the lower and upper cross bars 15, 16. Each guide assembly 20 extends over at least the vertical extent of this upper level 14. In contrast to the lower level 13, the upper level 14 thus always remains erected.

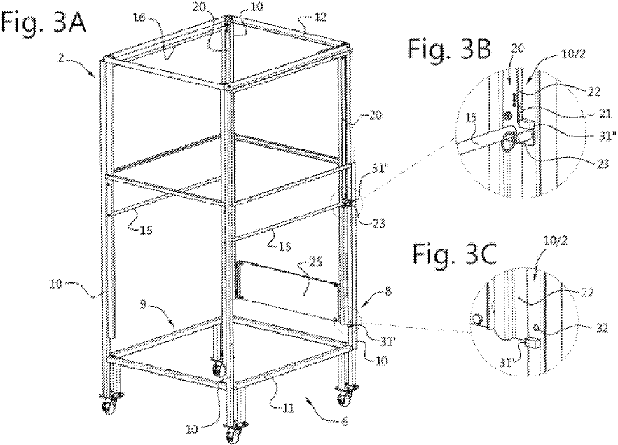

The guide assemblies 20 are vertically movable along the corner posts 10 of the frame 2 (not shown in FIGS. 2A-B), with one guide assembly 20 per corner post 10. To this end, each guide assembly 20 is provided at the bottom and top with a rolling element 21, for guiding along a guideway 22 formed by the frame 2. Optionally, the frame 2 comprises four profiled corner posts 10, the transverse profile of which forms a guideway 22 for guiding such rolling elements 21. See e.g. the horizontal section of FIG. 2C. Optionally, at least one of the guide assemblies 20 is further equipped with a transverse lock 23 - e.g. a plunger lock (not shown in FIGS. 2A-C, see e.g. FIG. 1A and FIGS. 3A-C.

FIG. 2A shows the lowered position of the compartment system 3. The lower level 13 of storage compartments 5′ has collapsed flexibly. The upper level 14 of storage compartments 5″ is erected above it. These compartments 5 are accessible from the front 6. The compartment system 3 is rectangularly suspended from four lifting belts 18 which extend vertically upwards. They extend from the guide assemblies 20 along the corner posts 10 (not shown in FIGS. 2A-B). At the top, the frame 2 (not shown in FIGS. 2A-B) provides belt guides 24, which the lifting belts 18 bend around laterally. The left-hand lifting belts 18′ run laterally as far as the right-hand belt guides 24″. There, the left and right lifting belts 18′, 18″ are combined, and combined and deflected downwards. Downward ends of the (combined) lifting belts 18 are coupled to a countermass 25. In particular, they are coupled to an upper edge 26 of the countermass 25, near two upper corners 27 of the countermass 25.

With this design, the lifting belts 18′, 18″ are bent downwards, at the top of the frame 2 (not shown in FIGS. 2A-B). An upward or downward movement of the compartment system 3 is therefore accompanied by a reciprocal downward or upward movement of the countermass 25. FIG. 2A shows the countermass 25 in its raised position. The main function of the belt guides 24 at the top of the frame 2 is to deflect the lifting belts 18 wrapped around it. They do not have the function of winding the lifting belts 18 around them; they are not a winch (as provided for with CZ 29 088 and SK 7781 from Keypack). The belt guides 24 can be of relatively small design. They preferably do not, or only barely, limit the usable height of the storage rack 1.

The countermass 25 is substantially rectangular and plate-shaped, adapted to move vertically upwards and downwards along the right-hand side 8 of the storage rack 1. The countermass 25 therefore does not hinder access to the storage compartments 5, along the front side 6. Furthermore, the countermass 25 is adapted to move parallel to the right-hand side 8 with its plate shape. Thus, the countermass 25 does not, or only barely, limit the usable width of the storage rack 1. Furthermore, the countermass 25 is provided with coupling points 28 near the upper corners 27, for coupling to the lifting belts 18. The countermass 25 is also equipped with rolling elements 29, coupled with further guideways 30 to the frame 2 (not drawn in FIGS. 2A-B, see the horizontal section of FIG. 2C). Optionally, the guideways 30 are provided laterally, relative to the corner posts 10 (solid line). Alternatively, the guideways 30 are enclosed between the corner posts 10 (dotted line), the countermass 25 extending between the corner posts 10 -with the advantage that they do not protrude relative to the frame 2. With a rectangular configuration of two rolling elements 29 at the top and bottom, enclosed on either side between guideways 30, the countermass 25 is restrained to at most a vertical upward or downward movement. In particular, the counterweight 25 is unable to ‘skew’ between the guideways 30.

FIG. 2B further shows the raised position of the compartment system 3. The lower level 13 of storage compartments 5′ is erected and accessible from the front 6. The upper level 14 of storage compartments 5″ has been erected above it. The upward movement of the compartment system 3 is accompanied by a reciprocal downward movement of the countermass 25 along the right-hand side 8.

Finally, FIGS. 3A-C illustrate a transverse lock 23, for selectively locking and unlocking the movement of the compartment system 3. For clarity, the storage compartments 5 have not been drawn. Optionally, the embodiment corresponds to FIGS. 1A-B.

FIG. 3A shows a frame 2 with four corner posts 10, a lower frame 11 and an upper frame 12. A movable guide assembly 20 is provided along each corner post 10. Each corner post 10 further forms a guideway 22. See also the detailed views of FIGS. 3B-C. The guideways 22 provide a vertical guidance of the guide assemblies 20 along the corner posts 10. Preferably, each guide assembly 20 is provided for this purpose with rolling elements 21 at the bottom and the top. Along the front side 6 and rear side 9, a lower and an upper cross bar 15, 16 are further provided, between the guide assemblies 20 on the left and right. The cross bars 15, 16 serve as suspension for the storage compartments 5. For example, they are encased in loops and/or eyes formed by the compartment material (not shown in FIGS. 3A-C).

Along the right side 8 the frame 2 is further equipped with a countermass 25. The countermass 25 is vertically movable along and between the right corner posts 10. Preferably, the countermass 25 is adapted to move reciprocally with the compartment system 3.

Along the front 6, the right-hand guide assembly 20 is further equipped with a transverse lock 23. Optionally, it is a manually operable plunger lock, accessible from the front 6. Preferably, the lock 23 is suitable for engaging transversely on the frame 2, for instance in a locking hole 32 provided on the frame 2. See FIG. 3C. With further preference, the lock 23 can be selectively disengaged and engaged. The movement of the guide assembly 20 is then correspondingly unlocked and locked.

The frame 2 further provides a lower stop 31′ and an upper stop 31″. Preferably, the stops 31′, 31″ are provided such that they limit the movement of the guide assembly 20, between an upper position and a lower position. The lower position corresponds to the lowered position of the compartment system 3. The upper position corresponds to the raised position of the compartment system 3. Preferably, the guide assembly 20 abuts directly against the corresponding stop 31′, 31″ in these positions. The stop 31 thus provides a support and already prevents the (spontaneous) movement of the compartment system 3 in one direction. The transverse lock 23 is preferably designed in such a way that it is able to lock the guide assembly 20 in question (and thus the compartment system 3) in both the lower position and the upper position.

The numbered elements in the figures are as follows:

| | |
|---|---|
| 1 | Storage rack |
| 2 | Frame |
| 3 | Compartment system |
| 4 | Wheel |
| 5 | Compartment |
| 6 | Front |
| 7 | Left side |
| 8 | Right side |
| 9 | Back |
| 10 | Corner post |
| 11 | Lower frame |
| 12 | Upper frame |
| 13 | Bottom level |
| 14 | Overlying/upper level |
| 15 | Lower cross bar |
| 16 | Overlying / upper cross bar |
| 17 | Eye |
| 18 | Lifting belt |
| 19 | End part (cross bar) |
| 20 | Guide assembly |
| 21 | Rolling element (compartment system) |
| 22 | Guideway (for compartment system) |
| 23 | Transverse lock |
| 24 | Belt guide |
| 25 | Countermass |
| 26 | Top edge (countermass) |
| 27 | Upper corner (countermass) |
| 28 | Coupling points |
| 29 | Rolling element (countermass) |
| 30 | Guideway (for countermass) |
| 31 | Stop |
| 32 | Locking hole |

It is believed that the present invention is not limited to the embodiments described above and that some modifications or changes may be added to the described examples and figures without revising the appended claims.

1. A storage device comprising a frame and a compartment system suspended within the frame, which compartment system comprises at least a lower level of storage compartments and an upper level of storage compartments, accessible from a front of the device, and suitable for the storage of general cargo, the device being further adapted for vertical movability of the compartment system between a lowered position and a raised position, within the frame,
in which lowered position the lower level has collapsed, with the upper level erected and accessible above it, and
in which raised position the lower level is erected and accessible, with the overlying level above it raised.
wherein the compartment system is rectangularly suspended from four lifting belts extending vertically upwards.

2. The storage device according to claim 1, further comprising a countermass adapted to move reciprocally with the compartment system, between a raised position and a lowered position.

3. The storage device according to claim 2, wherein the countermass is adapted to move along a side of the storage device, different from the front side.

4. The storage device according to claim 2, wherein the countermass is substantially plate-shaped, adapted to move parallelly along the storage.

5. The storage device according to claim 4, wherein the countermass is substantially rectangular and plate-shaped.

6. The storage device according to claim 2, wherein the lifting belts bend laterally at the top of the frame (2) and are coupled vertically downwards to the countermass.

7. The storage device according to claim 6, wherein the lifting belts combine in pairs at the top of the frame, and wherein each pair of lifting belts is combined and coupled downwards with the countermass.

8. The storage device according to claim 7, wherein the countermass comprises an upper edge part, to which upper edge part said pairs of lifting belts are coupled, each near a respective upper corner of the countermass.

9. The storage device according to claim 2 wherein the countermass is provided with guide means, adapted to guide the countermass rectangularly between two guideways provided on the frame.

10. The storage device according to claim 1, wherein the compartment system at the front provides a lower cross bar and an upper cross bar, movable vertically in the frame, from which cross bars respectively the lower and the upper level is suspended.

11. The storage device according to claim 10, wherein left end parts and right end parts of said cross bars are coupled to a left and a right guide assembly respectively, which guide assemblies are vertically movable along the frame.

12. The storage device according to claim 11, of which at least one guide assembly is provided with a transverse lock for selectively locking the vertical movement of the guide assembly.

13. The storage device according to claim 11, wherein the frame provides a lower stop and an upper stop limiting the movement of at least one guide assembly, between a lower and an upper position.

14. The storage device according to claim 12, wherein the lock is adapted to selectively lock the guide assembly in both the lower and the upper position.

15. The storage device according to claim 1, wherein each level provides a grid of storage compartments which are provided next to and above each other, wherein at least the lower level of storage compartments is made of a flexible material.

16. The use of a storage device according to claim 1, comprising loading general cargo into and/or unloading general cargo from one or more of the storage compartments.
